(19) United States
(12) Patent Application Publication
(10) Pub. No.: US 2012/0163025 A1
(43) Pub. Date: Jun. 28, 2012

(54) LIGHT GUIDE APPARATUS FOR A BACKLIGHT MODULE AND FABRICATING METHOD THEREOF

(75) Inventors: Chung-Lin Tsai, Taoyuan (TW); Ming-Yuan Lee, Taoyuan (TW); Tsung-Yung Hung, Taoyuan (TW); I-Ping Huang, Taoyuan (TW)

(73) Assignee: GLOBAL LIGHTING TECHNOLOGIES INC., Taoyuan (TW)

(21) Appl. No.: 13/172,890

(22) Filed: Jun. 30, 2011

Related U.S. Application Data
(63) Continuation-in-part of application No. 12/464,104, filed on May 12, 2009, now Pat. No. 7,997,784.

(51) Int. Cl. F21V 8/00; B29D 11/00

(52) U.S. Cl. 362/612; 362/611; 264/1.24

(57) ABSTRACT

A light guide apparatus for a backlight module is provided. The light guide apparatus comprises a light guide plate and a light source module. The light guide plate is configured with a circuit contact. The light source module is integrated with the light guide plate in contact with the circuit contact. Besides, a method of fabricating a light guide apparatus for a backlight module is also provided with simpler process and lower fabrication cost.

### CROSS-REFERENCE TO RELATED APPLICATION

This application is a continuation-in-part application of and claims the priority benefit of a prior application Ser. No. 12/464,104, filed on May 12, 2009, now pending. The entirety of the above-mentioned patent application is hereby incorporated by reference herein and made a part of this specification.

### BACKGROUND OF THE INVENTION

1. Field of the Invention

The present invention generally relates to a light guide apparatus for a backlight module and fabricating method thereof, in particular, to a light guide apparatus which integrates a light guide plate with a light source module together for obtaining simpler structure and lower cost.

2. Description of Related Art

Backlight modules are now widely used in many kinds of electronic products. For example, displays of notebook computers, mobile phones, and liquid crystal televisions do not emit light by themselves, and require backlight modules for providing light sources.

A typical backlight module includes a light guide plate and a light source. Light emitting diodes (LED) are often employed serving as light sources of backlight modules for those electronic products demanding a relatively thin thickness. With respect to such a backlight module, the LED light source is positioned at a lateral side of the light guide plate. The light guide plate has a first surface and a second surface opposite to the first surface. A reflective sheet is provided at the first surface, and a plurality of optical sheets including a diffusing sheet and a prism sheet are provided at the second surface. An outer frame is provided for framing all of the components. In operation, the LED light source emits a light, and the light is inputted into light guide plate from the lateral side of the light guide plate. A part of the light is reflected by the reflective sheet, and sequentially passes through the diffusing sheet and the prism sheet, and is then outputted therefrom.

When serving for a backlight module having a relatively small area, the light sources are usually provided at one lateral side of the light guide plate. However, when serving for a backlight module having a relatively large area, if the light sources are only provided at one side of the light guide plate, the light inputted into the light guide plate gradually attenuates while being transmitted to the other side of the light guide plate. This often causes a nonuniform illuminating condition of the light guide plate. As such, a large size light guide plate is often provided with light sources at both sides for solving the problem of the single side light sources.

FIG. 1 is a schematic diagram illustrating a conventional backlight module including a light guide plate and light sources assembled together. Referring to FIG. 1, no matter the light sources are provided to one side, two sides, or even more sides of the light guide plate 1, the conventional backlight module is generally configured by providing LEDs 2 onto a circuit board 3, and then assembling the LEDs 2 and the circuit board together to the lateral side(s) of the light guide plate 1. Accordingly, in fabricating such a backlight module, the LEDs 2 must be previously welded to the circuit board 3. Then, the circuit board 3, together with the LEDs 2 welded thereon, is secured to the light guide plate 1. As such, the process of the fabrication is relatively complex, and needs a high fabrication cost.

### SUMMARY OF THE INVENTION

Accordingly, the present invention is directed to a light guide apparatus for a backlight module which a light source module is directly integrated with the light guide plate by utilizing a circuit contact formed on the light guide plate.

The present invention is also directed to a method of fabricating a light guide apparatus for a backlight module which simplifies the process of the fabrication, and reduces the fabrication cost.

The present invention provides a light guide apparatus for a backlight module. The light guide apparatus comprises a light guide plate and a light source module. The light guide plate is configured with a circuit contact. The light source module is integrated with the light guide plate in contact with the circuit contact.

The present invention also provides a method of fabricating a light guide apparatus for a backlight module. The method of fabricating a light guide apparatus comprises the following steps, providing a mold assembly with a cavity and a injection hole connected with the cavity; disposing a light source module in the cavity; providing a material filling the cavity for forming a light guide plate to be integrated with light source module; and forming a circuit contact arranged on the light guide plate, and electrically connected to the light source module.

According to an embodiment of the present invention, the light source module comprises an LED die without resin package.

According to an embodiment of the present invention, the light guide plate is made of a material selected from a group consisting of polymethyl methacrylate (PMMA), polycarbonate (PC), polystyrene (PS), polypropylene (PP) and combination thereof.

According to an embodiment of the present invention, the light source module comprises an LED die having an anode and a cathode; and a carrier for carrying the LED die.

According to an embodiment of the present invention, the light source module further comprises a conductive adhesive disposed between the cathode of the LED die and the carrier.

According to an embodiment of the present invention, the light source module further comprises a conductive wire bridging the anode of the LED die and the carrier.

According to an embodiment of the present invention, the mold assembly comprises a first mold; and a second mold, in combination with the first mold for forming the cavity and the injection hole.

According to an embodiment of the present invention, the mold assembly further comprises a gate disposed at the injection hole for switching the injection hole.

In the invention, the light guide plate is configured with a circuit contact, and the light source module is integrated with the light guide plate in contact with the circuit contact. Therefore, a structure of the light guide apparatus becomes simple and compact. Due to the simple structure of the light guide apparatus, the method of fabricating the light guide apparatus has simpler fabrication process and lower fabrication cost.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating a conventional backlight module including a light guide plate and light sources assembled together.

FIG. 2 is a perspective view showing a light guide apparatus that a light source module is integrated with the light guide plate in contact with a circuit contact formed on the light guide plate according to an embodiment of the present invention.

FIG. 3A is a perspective view showing that a structure of a light source module according to an embodiment of the present invention.

FIG. 3B is a cross-sectional view of the light source module along line A-A in the FIG. 3A.

FIG. 3C is a light source module with resin package according to another embodiment of the present invention.

FIGS. 4-5 are process flow showing that a method of fabricating a light guide apparatus according to an embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

### Light Guide Apparatus for a Backlight Module

FIG. 2 is a perspective view showing a light guide apparatus that a light source module is integrated with the light guide plate in contact with a circuit contact formed on the light guide plate according to an embodiment of the present invention. Please referring to FIG. 2, the light guide apparatus 10 includes a light guide plate 1 and a light source module 5. The light guide plate 1 is configured with at least a circuit contact 12 (two circuit contacts are shown is FIG. 2). The light source module 5 is integrated with the light guide plate 1 in contact with the circuit contact 12.

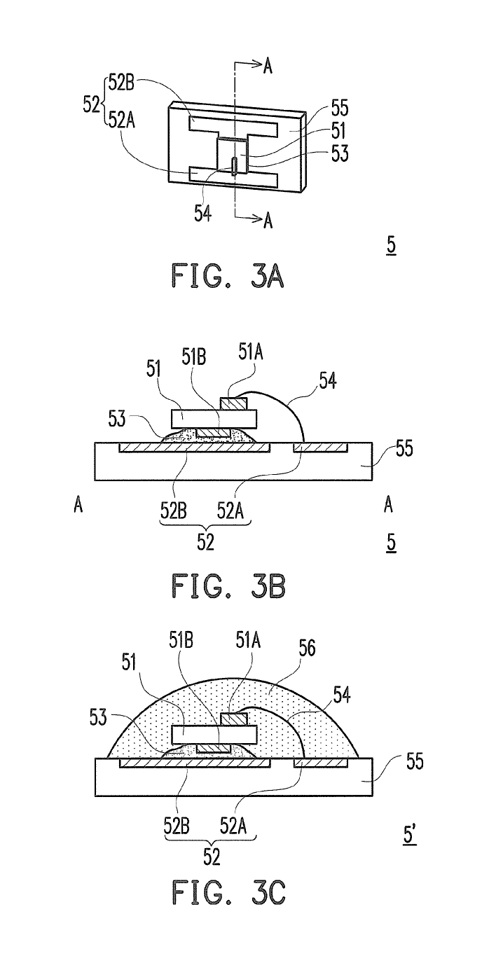

FIG. 3A is a perspective view showing that a structure of a light source module according to an embodiment of the present invention. FIG. 3B is a cross-sectional view of the light source module along line A-A in the FIG. 3A. Please referring to FIGS. 3A and 3B, the light source module 5 may comprises an LED die 51 having an anode 51A and a cathode 51B; and a carrier 52 for carrying the LED die 51. Moreover, as shown in FIGS. 3A and 3B, the light source module 5 may further comprises a conductive adhesive 53 disposed between the cathode 51B of the LED die 51 and the carrier 52. The conductive adhesive 53 can be anisotropic conductive paste, silver paste, conductive polymer paste or the like. Besides, the light source module 5 may further comprises a conductive wire 54 bridging the anode 51A of the LED die 51 and the carrier 52.

Referring to FIGS. 3A and 3B, the carrier 52 may include an anode portion 52A and a cathode portion 52B. The anode portion 52A is electrically connected with the anode 51A of the LED die 51 through the conductive wire 54. And, the cathode portion 52B is electrically connected with the cathode 51B of the LED die 51 through the conductive adhesive 53. Moreover, the light source module 5 may include a substrate 55, which the LED die 51 and the carrier 52 are disposed thereon. The substrate 55 can be a transparent substrate utilizing transparent plastic material as same as the light guide plate 1. For example, the light guide plate 1 can be made of a material selected from a group consisting of polymethyl methacrylate (PMMA), polycarbonate (PC), polystyrene (PS), polypropylene (PP) and combination thereof.

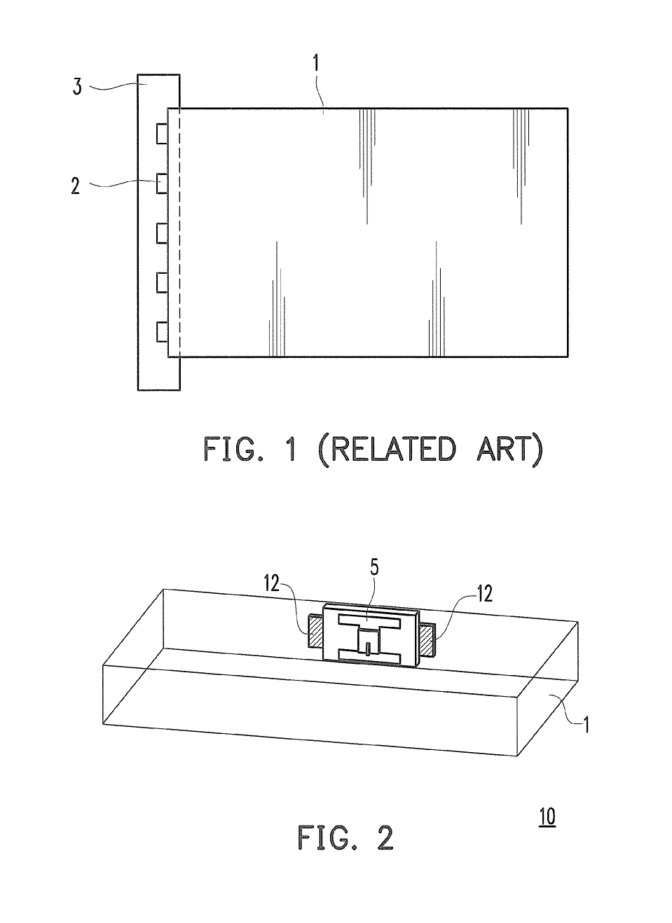

Referring to FIG. 3B again, the light source module 5 may include an LED die 51 without resin package. Therefore, the LED die 51 without resin package can be packaged by the light guide plate 1 directly (as shown in the FIG. 1) and resin packaging process for the LED die 51 can be saved. Therefore, the process of the fabrication can be simplified, and the fabrication cost can be reduced.

FIG. 3C is a light source module with resin package according to another embodiment of the present invention. Please referring to FIG. 3C, the light source module 5′ may also include an LED die 51 with resin package 56 so as to more properly protect the light source module 5′ from being damaged. In the resin package 56, phosphor coating (not shown) can also be distributed and the phosphor can be excited by a light emitted from the LED die 51 for converting the light into a different color light. Then, the light and the color light can be mixed to form another desired color light. The light source module 5′ can also be integrated with the light guide plate 1 in contact with the circuit contact 12.

In brief, the light guide plate 1 can be configured with circuit contacts 12, and the light source module 5 and 5′ can be directly packaged by the light guide plate 1 at suitable position and electrically connected with the circuit contact 12. Therefore, electrical components (i.e, light source module 5 and 5′, and circuit contact 12) can be integrated with the light guide plate 1 without introducing any other circuit board, and the structure of the light guide apparatus 10 become simple and compact.

### Method of Fabricating a Light Guide Apparatus for a Backlight Module

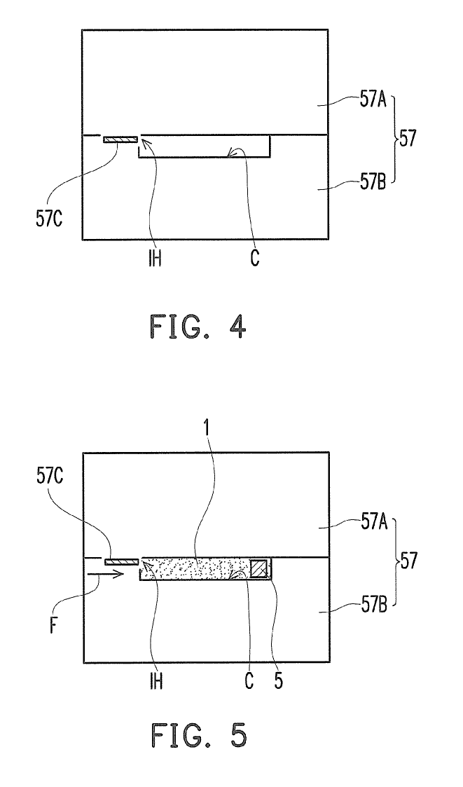

FIGS. 4-5 are process flow showing that a method of fabricating a light guide apparatus according to an embodiment of the present invention. Please referring to FIG. 4, a mold assembly 57 with a cavity C and an injection hole IH connected with the cavity C is provided. For example, the mold assembly 57 may comprise a first mold 57A; and a second mold 57B, in combination with the first mold 57A for forming the cavity C and the injection hole IH. The first mold 57A can be moved relatively to the second mold 57B. When the first mold 57A is separated from the second mold 57B, electrical components (such as light source module 5 and 5′) can be disposed on the second mold 57B. When the first mold 57A is in combination with the second mold 57B, electrical components (such as light source module 5 and 5′) can be disposed in the cavity C.

Referring to FIG. 4 again, a light source module 5 can be disposed in the cavity C. The light source module 5 can be any one thereof described in the FIGS. 3A-3C, or other suitable point light source.

Then, referring to FIG. 5, providing a material (as indicated by the arrow F) filling the cavity C for forming a light guide plate 1 to be integrated with light source module 5. The mold assembly 57 may further comprises a gate 57C disposed at the injection hole IH for switching the injection hole IH. Therefore, the material flow indicated by the arrow F can flow into the cavity C for simultaneously form the light guide plate 1 and packaging the light source module 5.

Moreover, a circuit contact 12 (as shown in FIG. 2) is arranged on the light guide plate, and electrically connected to the light source module 5. In detail, the step of arranging the circuit contact 12 can be implemented after or before forming the light guide plate 1 and packaging the light source module 5. The circuit contact 12 can be disposed for being electrically connected with the light source module 5 which has been already packaged by the light guide plate 1. Alternatively, the circuit contact 12 and the light source module 5 can be disposed in the cavity C together and being electrical connected with each other first, and then being packaged by the light guide plate 1. Finally, a light guide apparatus 10 for a backlight module (as shown in FIG. 1), which integrates the light source module 5 with the light guide plate 1, is accomplished. Then, the light guide apparatus 10 can be taken out by separating the first mold 57A and the second mold 57B.

In the above method of fabricating a light guide apparatus for a backlight module, the structure details of the light source module 5 and 5′ are similar to thereof described in FIGS. 2-3C, thus the same components are denoted with the same notations and the descriptions thereof are omitted. The method of fabricating a light guide apparatus can integrated with the light source module 5 and 5′ with the light guide plate 1 having circuit contacts 12. Therefore, fabricating process is simplified and electrical element (such as circuit board) can be saved. Especially, when an LED die 51 without resin package is packaged by the light guide plate 1 directly, a resin packaging process for the LED die 51 can be further omitted. To sum up, the method of fabricating the light guide apparatus 10 has simpler fabrication process and lower fabrication cost.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A light guide apparatus for a backlight module, comprising:
a light guide plate configured with a circuit contact; and
a light source module integrated with the light guide plate in contact with the circuit contact.

2. The light guide apparatus as claimed in claim 1, wherein the light source module comprises an LED die without resin package.

3. The light guide apparatus as claimed in claim 1, wherein the light guide plate is made of a material selected from a group consisting of PMMA, PC, PS, PP and combination thereof.

4. The light guide apparatus as claimed in claim 1, wherein the light source module comprising:
an LED die having an anode and a cathode; and
a carrier for carrying the LED die.

5. The light guide apparatus as claimed in claim 4, further comprising:
a conductive adhesive disposed between the cathode of the LED die and the carrier.

6. The light guide apparatus as claimed in claim 4, further comprising:
a conductive wire bridging the anode of the LED die and the carrier.

7. A method of fabricating a light guide apparatus for a backlight module, comprising:
providing a mold assembly with a cavity and a injection hole connected with the cavity ;
disposing a light source module in the cavity;
providing a material filling the cavity for forming a light guide plate to be integrated with light source module; and
forming a circuit contact arranged on the light guide plate, and electrically connected to the light source module.

8. The method as claimed in claim 7, wherein the light source module comprises an LED die without resin package.

9. The method as claimed in claim 7, wherein the light guide plate is made of a material selected from the group consisting of PMMA, PC, PS, PP and combination thereof.

10. The fabricating method as claimed in claim 7, wherein the light source module comprising:
an LED die has an anode and a cathode; and
a carrier for carrying the LED die.

11. The method as claimed in claim 10, further comprising:
a conductive adhesive disposed between the cathode of the LED die and the carrier.

12. The method as claimed in claim 10, further comprising:
a conductive wire bridging the anode of the LED die and the carrier.

13. The method as claimed in claim 7, wherein the mold assembly comprising:
a first mold; and
a second mold, in combination with the first mold for forming the cavity and the injection hole.

14. The fabricating method as claimed in claim 7, wherein the mold assembly further comprising:
a gate disposed at the injection hole for switching the injection hole.
